(19) United States
(12) Patent Application Publication
(10) Pub. No.: US 2007/0206891 A1
(43) Pub. Date: Sep. 6, 2007

(54) COMPOSITE-FILM BEARINGS

(75) Inventor: Andras Z. Szeri, Hockessin (DE)

Correspondence Address: CONNOLLY BOVE LODGE & HUTZ LLP, 1875 EYE STREET, N.W., SUITE 1100, WASHINGTON, DC, 20036, US

(73) Assignee: UNIVERSITY OF DELAWARE, Newark (DE)

(21) Appl. No.: 11/464,379

(22) Filed: Aug. 14, 2006

Related U.S. Application Data
(60) Provisional application No. 60/707,552, filed on Aug. 12, 2005.

(51) Int. Cl. F16C 32/06

(52) U.S. Cl. 384/121

(57) ABSTRACT

Hydrodynamic bearings providing reduced friction are provided. The bearings include a load-transferring element and a porous bearing pad spaced from the load-transferring element. The load-transferring element is provided with a high-viscosity lubricant. The porous bearing pad is saturated with a low-viscosity lubricant. The high-viscosity lubricant and the low-viscosity lubricant are drawn into the clearance space by hydrodynamic action to form a bi-component lubricant film. The bi-component lubricant film includes a high-viscosity film layer and a low-viscosity film layer, which provide reduced viscous dissipation as well as proper cooling and lubrication.

This application claims the benefit of U.S. Appl. No. 60/707,552, filed Aug. 12, 2005.

### FIELD OF THE INVENTION

The invention relates to hydrodynamic bearings.

### BACKGROUND OF THE INVENTION

Experts estimate that, in 1978, over 4.22×10¹⁸ joules of energy were lost in the United States due to simple friction and wear. This is enough energy to supply New York City for an entire year. Energy loss through tribological elements, such as bearings, is a major factor in limitations on energy efficiency. One avenue that can be pursued for reducing frictional losses in tribological elements is modification of the lubricant film used in these elements.

Hydrodynamic bearings are used to support rotating or reciprocating parts in many different types of machinery such as automobile engines, jet engines, power generating equipment, cooling pumps for nuclear power plants and metal working equipment (e.g., strip rolling equipment). Hydrodynamic bearings are typically lubricated with high-viscosity fluids to promote the formation of thick lubricant films that separate the load-bearing surfaces of the bearing and ensure good cooling. However, the use of high-viscosity lubricants results in large frictional energy losses (i.e., viscous dissipation). For example, bearings in large rotating machinery, such as machinery in power generation plants, can dissipate hundreds of horsepower per bearing.

Employing a low-viscosity lubricant is often not a viable solution for reducing energy losses in bearings, because, although the use of low-viscosity lubricants can reduce viscous dissipation, low-viscosity lubricants are often incapable of providing adequately thick films to ensure proper separation of the load-bearing surfaces and adequate cooling in the bearing.

It is an objective to provide the performance benefits of both high-viscosity lubricants and low-viscosity lubricants in hydrodynamic bearings, while avoiding the performance disadvantages of these lubricants. Another objective is to achieve the aforementioned benefits in a cost-efficient manner.

### SUMMARY OF THE INVENTION

The disclosed hydrodynamic bearings include a bi-component lubricant film between load-bearing surfaces to provide superior protection and minimization of frictional energy loss in the bearings. The hydrodynamic bearings disclosed herein are useful in various types of machinery employing rotating or reciprocating parts. Such machinery includes, but is not limited to automobile engines, jet engines, power generating equipment, cooling pumps for nuclear power plants and metal working equipment (e.g., strip rolling equipment).

The disclosure generally concerns hydrodynamic bearings comprising: a load-transferring element provided with a high-viscosity lubricant; a load-bearing element spaced from the load-transferring element; a porous bearing pad supported by the load-bearing element and saturated with a low-viscosity lubricant; and a bi-component, dual-layer lubricant film disposed in a clearance space between the load-transferring element and the bearing pad, wherein the bi-component lubricant film comprises a first layer comprising the high-viscosity lubricant and a second layer comprising the low-viscosity lubricant, wherein the load-transferring element is arranged to draw the high-viscosity lubricant into the clearance space and wherein the low-viscosity lubricant is arranged to seep into the clearance space from the bearing pad.

According to one embodiment, a hydrodynamic thrust bearing is provided. The thrust bearing includes: a rotatable runner provided with a high-viscosity lubricant; a thrust plate axially spaced from the rotatable runner; a porous bearing pad supported by the thrust plate and saturated with a low-viscosity lubricant; and a hi-component, dual-layer lubricant film disposed in a clearance space between the runner and the bearing pad, wherein the bi-component lubricant film comprises a first layer comprising the high-viscosity lubricant and a second layer comprising the low-viscosity lubricant, wherein the runner is arranged to draw the high-viscosity lubricant into the clearance space and wherein the porous bearing pad is arranged to allow the low-viscosity lubricant to seep into the clearance space from the bearing pad.

According to another embodiment, a journal bearing assembly comprising a hydrodynamic journal bearing and a rotatable journal is provided. The rotatable journal is provided with a high-viscosity lubricant. The journal bearing includes a bearing shell radially spaced from the journal; a porous bearing pad supported by an interior surface of the bearing shell and saturated with a low-viscosity lubricant; and a bi-component, dual-layer lubricant film disposed in a clearance space between the journal and the bearing pad, wherein the bi-component lubricant film comprises a first layer comprising the high-viscosity lubricant and a second layer comprising the low-viscosity lubricant, wherein the journal is arranged to draw the high-viscosity lubricant into the clearance space and wherein the porous bearing pad is arranged to allow the low-viscosity lubricant to seep into the clearance space from the bearing pad.

The invention also concerns a method of lubricating a hydrodynamic bearing, comprising: introducing a high-viscosity lubricant to a load-transferring element of the bearing such that the high-viscosity lubricant is dragged into a clearance space between the load-transferring element and a porous bearing pad of the bearing by rotation of the runner; saturating the porous bearing pad with a low-viscosity lubricant such that the low-viscosity lubricant seeps into a clearance space between the load-transferring element and the bearing pad and is dragged through the clearance space by the high-viscosity lubricant; and forming a bi-component lubricant film in the clearance space, wherein the bi-component lubricant film comprises a first layer comprising the high-viscosity lubricant and a second layer comprising the low-viscosity lubricant.

In operation of the bearings of the invention, the bi-component film reduces viscous dissipation and possesses a desirable thickness for effective protection and cooling. The arrangement of the bi-component lubricant film effectively allows the second, low-viscosity film layer to act as a lubricant for the first, high-viscosity film layer.

According to further embodiments of the invention, the bearing pad may be provided with graded porosity or parts or layers of varying porosity to promote desired lubricant storage and circulation at strategic locations, as well as to facilitate separation of the low-viscosity and high-viscosity lubricants as the bi-component lubricant film emerges from the clearance space of the bearing.

Further features and advantages of the invention will be apparent from the detailed description and drawings that follow.

### BRIEF DESCRIPTION OF THE DRAWINGS

FIG. 1 is a schematic illustration of a thrust bearing according to an embodiment of the invention.

FIG. 2 is a partial sectional view of the thrust bearing of FIG. 1.

FIG. 3 is a schematic illustration of a journal bearing assembly according to an embodiment of the invention.

FIG. 4 is a partial sectional view of the journal bearing of FIG. 3.

### DETAILED DESCRIPTION OF THE INVENTION

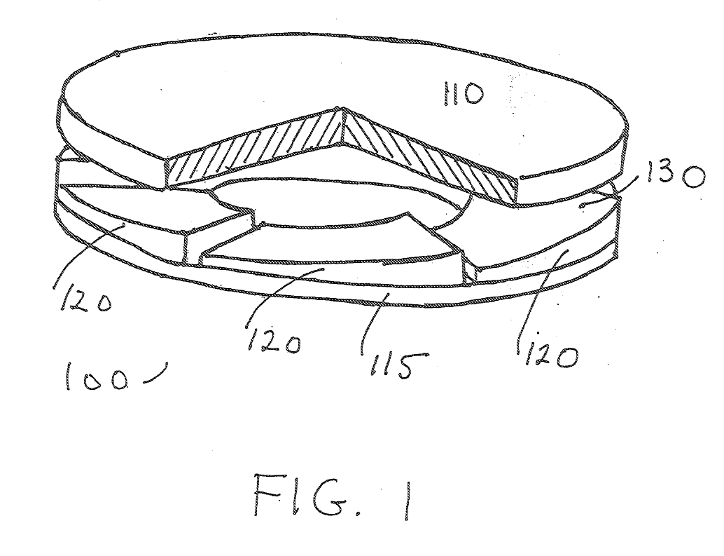

Improved composite-film, hydrodynamic bearings including a bi-component lubricant film are shown in FIGS. 1-4. The invention will be described in detail with respect to the figures.

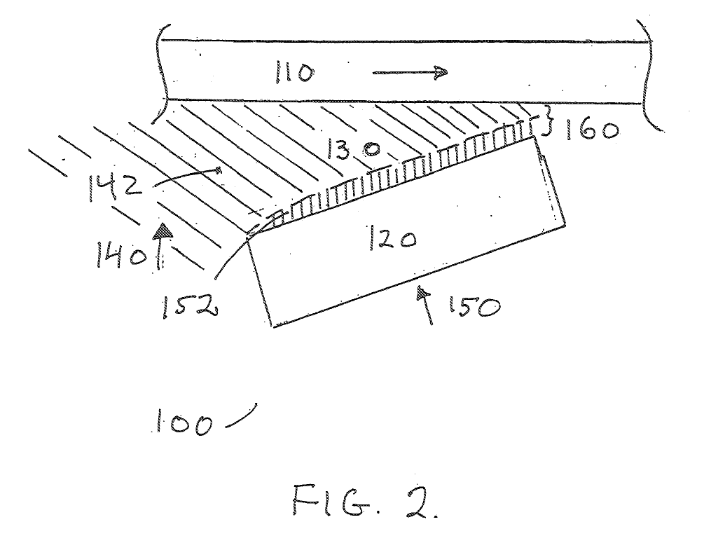

FIGS. 1 and 2 show a thrust bearing 100 according to an embodiment of the invention. The thrust bearing 100 includes a load-transmitting, rotatable or reciprocatable runner 110, a load-bearing element or thrust plate 115 axially spaced from the runner 110 and at least one porous bearing pad 120 supported by the thrust plate 115. The runner 110 may be constructed, for example, of steel coated with tin-base alloys, lead-base alloys, copper-lead alloys, bronzes, or other suitable materials. The bearing pad 120 may be constructed, for example, of sintered metals or other suitable materials. A clearance space 130 is disposed between the runner 110 and the bearing pad 120. A dual-layer, hi-component lubricant film 160 is disposed in the clearance space 130 for lubricating the runner 110 and the bearing pad 120. The thrust bearing 100 may vary in size depending on the particular application. For example, the bearing 100 may have a diameter ranging from 1/100^{th} of a meter to 1 meter or larger. Correspondingly, the height of the clearance space 130 will vary with the size of the bearing 100 and may be about 1/1000^{th} of the diameter of the bearing 100.

The runner 110 is supplied with a high-viscosity lubricant 140 from a first lubricant source (not shown). The bearing pad 120 is supplied with a low-viscosity lubricant 150 from a second lubricant source (not shown), under pressure, such that the bearing pad 120 is saturated with the low-viscosity lubricant 150 and the low-viscosity lubricant 150 seeps into a low pressure zone of the clearance space 130. The high-viscosity lubricant 140 and the low-viscosity lubricant 150 are immiscible with respect to each other. The high-viscosity lubricant 140 may comprise, for example, synthetic oil or heavy mineral oil (e.g., ISO Grade 32 lube oil). The low-viscosity lubricant 150 may comprise, for example, water. However, other suitable lubricants may be used so long as the viscosities of the two lubricants are significantly different. For example, the viscosity of the low-viscosity lubricant 150 maybe about 1/100th of the viscosity of the high-viscosity lubricant 140.

As the runner 110 rotates or reciprocates, the runner 110 drags the high-viscosity lubricant 140 into the clearance space 130 by hydrodynamic action, thereby forming a high-viscosity film layer 142 including the high-viscosity lubricant 140. As the low-viscosity lubricant 150 seeps into the clearance space 130, the high-viscosity film layer 142 drags the low-viscosity lubricant 150 through the clearance space 130, thereby forming a low-viscosity film layer 152 including the low-viscosity lubricant 150. The high-viscosity and low-viscosity film layers 142 and 152 interact in the clearance space 130 to form the bi-component film 160.

The bi-component film 160 naturally seeks a loading configuration that minimizes viscous dissipation. Therefore, deformation, and thus viscous dissipation, is localized to the low-viscosity film layer 152, which is disposed between the high viscosity film layer 142 and the bearing pad 120. The low-viscosity film layer 152 reduces viscous dissipation in the bearing 100, while the high-viscosity film layer 142 ensures that the bi-component film 160 possesses a desirable thickness for maintaining separation between the runner 110 and the bearing pad 120. The described arrangement of the high-viscosity and low-viscosity film layers 142 and 152 effectively allows the low-viscosity film layer 152 to act as a lubricant for the high-viscosity film layer 142.

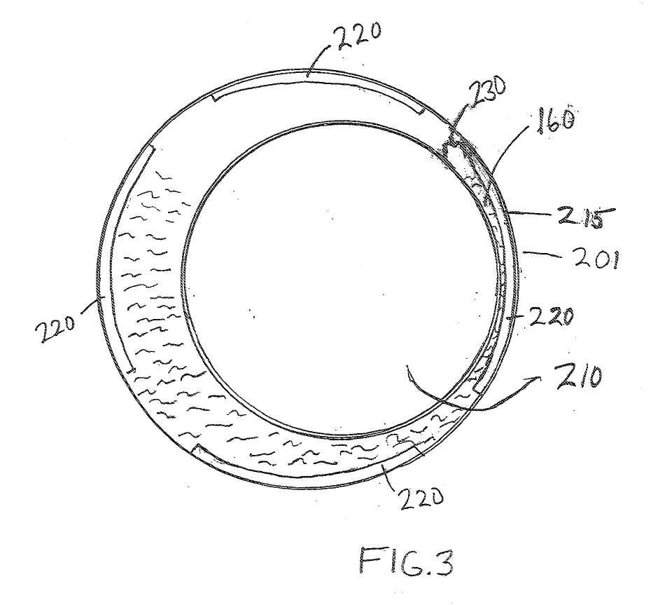

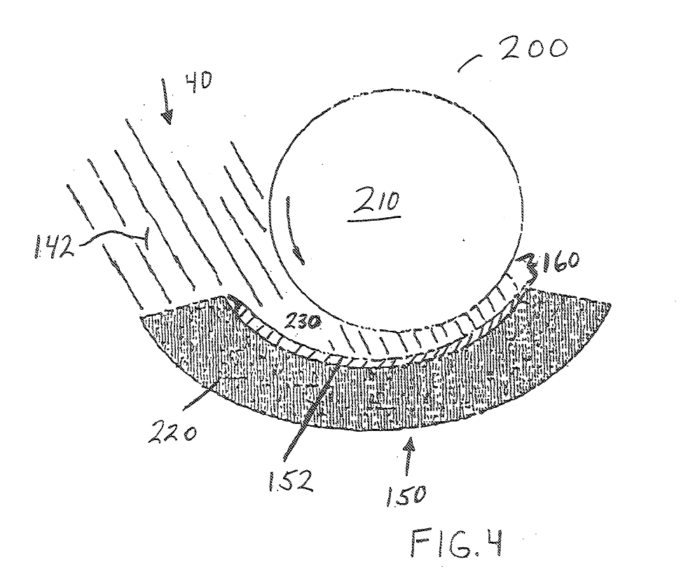

FIGS. 3 and 4 show a journal bearing assembly 200 according to another embodiment of the invention, wherein reference numbers shared with FIGS. 1 and 2 indicate similar elements. The bearing assembly 200 includes a journal bearing 201 and a load-transmitting, rotatable or reciprocatable journal 210. The journal bearing 201 may either be a full 360 degree bearing or a partial arc bearing. The journal bearing 201 includes a load-bearing element or bearing shell 215 that is radially spaced from the journal 210 and at least one porous bearing pad 220 that is disposed inside the shell 215 and supported by an interior surface of the shell 215. The shell 215 may be constructed from, for example, tin-base alloys, lead-base alloys, copper-lead alloys, bronzes or other suitable materials. The journal 210 may be constructed from, for example, hard steel or other suitable materials, coated with tin-base alloys, lead-base alloys, copper-lead alloys, bronzes or other suitable materials. The bearing pad 220 may be constructed from, for example, sintered metals or other suitable materials. A clearance space 230 is disposed between the journal 210 and the bearing pad 220. A dual-layer, bi-component lubricant film 160 is disposed in the clearance space 230 for lubricating the journal 210 and the bearing pad 220.

The journal 210 is supplied with a high-viscosity lubricant 140 from a first lubricant source (not shown). The bearing pad 220 is supplied with a low-viscosity lubricant 150 from a second lubricant source (not shown), under pressure, such that the bearing pad 220 is saturated with the low-viscosity lubricant 150 and the low-viscosity lubricant 150 seeps into a low pressure zone of the clearance space 230.

As the journal 210 rotates or reciprocates, the journal 210 drags the high-viscosity lubricant 140 into the clearance space 230 by hydrodynamic action, thereby forming a high-viscosity film layer 142 including the high-viscosity lubricant 140. As the low-viscosity lubricant 150 seeps into the clearance space 230, the high-viscosity film layer 142 drags the low-viscosity lubricant 150 through the clearance space 230, thereby forming a low-viscosity film layer 152 including the low-viscosity lubricant 150. The high-viscosity and low-viscosity film layers 142 and 152 interact in the clearance space 230 to form the bi-component film 160.

The bi-component film 160 behaves here as it does in the previous embodiment. That is, the bi-component film 160 naturally seeks a loading configuration that minimizes viscous dissipation. The result is a configuration in which deformation and viscous dissipation is localized to the low-viscosity film layer 152, and in which the low-viscosity film layer 152 is disposed between the high-viscosity film layer 142 and the bearing pad 220. The low-viscosity film layer 152 reduces viscous dissipation in the bearing 201, while the high-viscosity film layer 142 ensures that the hi-component film 160 possesses a thickness suitable for maintaining separation between the journal 210 and the bearing pad 220. As in the previous embodiment, the arrangement of the high-viscosity and low-viscosity film layers 142 and 152 effectively allows the low-viscosity film layer 152 to act as a lubricant for the high-viscosity film layer 142.

The disclosed bearing pads 120, 220 may be made of composite porous materials in order to control seepage flow. That is, the bearing pads 120, 220 may be constructed of parts or layers having different porosities or materials having graded porosity. Parts or layers of relatively low permeability may be employed to inhibit seepage flow, while parts or layers of high permeability may be employed to promote seepage flow, as desired. Thus, circulation and storage of the low-viscosity lubricant 150 can be controlled by the porosity of the bearing pads 120, 220 at given locations. Additionally, low permeability of the bearing pads 120, 220 in the high pressure zones of the bearing will increase load capacity and reduce friction. Thus, differential or graded permeability can be used to provide low permeability in the bearing pads 120, 220 in the high pressure zones of the bearings 100, 200.

It is also useful to be able to separate the high-viscosity lubricant 140 from the low-viscosity lubricant 150 as the bi-component lubricant film 160 emerges from the clearance spaces 130, 230 so that the lubricants 140 and 150 can be re-circulated in the bearings 100, 200. The separation of the lubricants 140 and 150 can also be facilitated by employing bearing pads 120, 220 having graded porosity, or having parts or layers of different porosities at strategic locations. For example, the bearing pads 120, 220 or certain layers or parts thereof, may have a porosity such that they are impermeable with respect to the high-viscosity lubricant.

The bearings 100, 201 may also be provided with feeding grooves (not shown) in the load-bearing surfaces of the bearing pads 120, 220 to facilitate proper flow of the low-viscosity lubricant 150.

The bearings 100, 200 provide increased efficiency due to reduced viscous dissipation in the thin, low-viscosity film layer 152 and also provide adequate cooling and protection by means of the thick, high-viscosity film layer 142. When the viscosity of the low-viscosity lubricant 150 is about 1/100^{th} of the viscosity of the high-viscosity lubricant 140, the energy loss in the bearing 100, 200 may be as little as 1/10^{th} of the power loss experienced in similarly sized bearings employing traditional lubricants.

Although the disclosure references specific embodiments shown in FIGS. 1-4, the disclosure is not limited to these embodiments. The disclosure applies to variations of bearings and bearing assemblies not expressly discussed herein. For example, the invention also pertains to any hydrodynamic bearing or assembly including a load-transferring element other than a runner or a journal. It will be apparent to those of skill in the art that it is possible to modify or alter the various details discussed herein without departing from the spirit and scope of the invention.

I claim:

1. A hydrodynamic bearing comprising:
a rotatable runner provided with a high-viscosity lubricant;
a thrust plate axially spaced from the runner;
at least one porous bearing pad supported by the thrust plate and saturated with a low-viscosity lubricant; and
a bi-component, dual-layer lubricant film disposed in a clearance space between the runner and the at least one porous bearing pad, wherein the bi-component lubricant film includes a first layer comprising the high-viscosity lubricant and a second layer comprising the low-viscosity lubricant.

2. The hydrodynamic bearing of claim 1, wherein the runner is arranged to draw the high-viscosity lubricant into the clearance space and wherein the at least one porous bearing pad is arranged to allow the low-viscosity lubricant to seep into the clearance space from the at least one porous bearing pad.

3. The hydrodynamic bearing of claim 1, wherein the at least one porous bearing pad is of graded porosity.

4. The hydrodynamic bearing of claim 1, wherein the at least one porous bearing pad includes parts or layers of varying porosity.

5. The hydrodynamic bearing of claim 1, wherein at least a portion of the at least one porous bearing pad is impermeable with respect to the high-viscosity lubricant.

6. The hydrodynamic bearing of claim 1, wherein the high-viscosity lubricant comprises synthetic oil or mineral oil and the low-viscosity lubricant comprises water.

7. The hydrodynamic bearing of claim 1, wherein the low-viscosity lubricant has a viscosity that is about 1/100^{th} of a viscosity of the high-viscosity lubricant.

8. A hydrodynamic bearing assembly comprising:
a rotatable journal provided with a high-viscosity lubricant;
a journal bearing comprising a bearing shell radially spaced from the journal;
at least one porous bearing pad supported by an interior surface of the bearing shell and saturated with a low-viscosity lubricant; and
a bi-component, dual-layer lubricant film disposed in a clearance space between the journal and the at least one porous bearing pad, wherein the bi-component lubricant film includes a first layer comprising the high-viscosity lubricant and a second layer comprising the low-viscosity lubricant.

9. The hydrodynamic bearing of claim 8, wherein the journal is arranged to draw the high-viscosity lubricant into the clearance space and wherein the at least one porous bearing pad is arranged to allow the low-viscosity lubricant to seep into the clearance space from the at least one porous bearing pad.

10. The hydrodynamic bearing assembly of claim 8, wherein the at least one porous bearing pad is of graded porosity.

11. The hydrodynamic bearing assembly of claim 8, wherein the at least one porous bearing pad includes parts or layers of varying porosity.

12. The hydrodynamic bearing assembly of claim 8, wherein at least a portion of the bearing pad is impermeable with respect to the high-viscosity lubricant.

13. The hydrodynamic bearing assembly of claim 8, wherein the high-viscosity lubricant comprises synthetic oil or mineral oil and the low-viscosity lubricant comprises water.

14. The hydrodynamic bearing assembly of claim 9, wherein the low-viscosity lubricant has a viscosity that is about 1/100^{th} of a viscosity of the high-viscosity lubricant.

15. A method of lubricating a hydrodynamic bearing, comprising:
introducing a high-viscosity lubricant to a load-transferring element of the bearing such that the high-viscosity lubricant is dragged into a clearance space between the load-transferring element and at least one porous bearing pad of the bearing by rotation of the runner;
saturating the porous bearing pad with a low-viscosity lubricant such that the low-viscosity lubricant seeps into a clearance space between the load-transferring element and the at least one porous bearing pad and is dragged through the clearance space by the high-viscosity lubricant; and
forming a bi-component lubricant film in the clearance space, wherein the bi-component lubricant film comprises a first layer comprising the high-viscosity lubricant and a second layer comprising the low-viscosity lubricant.

16. The method of claim 15, wherein the high-viscosity lubricant comprises synthetic oil or mineral oil and the low-viscosity lubricant comprises water.

17. The method of claim 15, wherein the low-viscosity lubricant has a viscosity that is about 1/100th of a viscosity of the high-viscosity lubricant.

18. The method of claim 15, further comprising separating the high-viscosity lubricant from the low-viscosity lubricant as the bi-component lubricant film emerges from the clearance space.

19. The method of claim 15, wherein the load-transferring element is runner.

20. The method of claim 15, wherein the load-transferring element is a journal.

21. A hydrodynamic bearing comprising:
a load-transferring element provided with a high-viscosity lubricant; a load-bearing element spaced from the load-transferring element;
at least one porous bearing pad supported by the load-bearing element and saturated with a low-viscosity lubricant; and
a bi-component, dual-layer lubricant film disposed in a clearance space between the load-transferring element and the at least one porous bearing pad, wherein the bi-component lubricant film comprises a first layer comprising the high-viscosity lubricant and a second layer comprising the low-viscosity lubricant.

22. The hydrodynamic bearing of claim 21, wherein the load-transferring element is arranged to draw the high-viscosity lubricant into the clearance space and wherein the at least one porous bearing pad is arranged to allow the low-viscosity lubricant to seep into the clearance space from the at least one porous bearing pad.

23. The hydrodynamic bearing of claim 21, wherein the at least one porous bearing pad is of graded porosity.

24. The hydrodynamic bearing of claim 21, wherein the at least one porous bearing pad includes parts or layers of varying porosity.

25. The hydrodynamic bearing of claim 21, wherein at least a portion of the at least one porous bearing pad is impermeable with respect to the high-viscosity lubricant.

26. The hydrodynamic bearing of claim 21, wherein the high-viscosity lubricant comprises synthetic oil or mineral oil and the low-viscosity lubricant comprises water.

27. The hydrodynamic bearing of claim 21, wherein the low-viscosity lubricant has a viscosity that is about 1/100^{th} of a viscosity of the high-viscosity lubricant.

28. A hydrodynamic journal bearing comprising:
a bearing shell;
at least one porous bearing pad supported by an interior surface of the bearing shell and saturated with a low-viscosity lubricant; and
a bi-component, dual-layer lubricant film disposed in an interior space of said bearing, wherein the bi-component lubricant film includes a first layer comprising the high-viscosity lubricant and a second layer comprising the low-viscosity lubricant.

29. The hydrodynamic journal bearing of claim 28, wherein the at least one porous bearing pad is arranged to allow the low-viscosity lubricant to seep into the interior space from the at least one porous bearing pad.

30. The hydrodynamic journal bearing of claim 28, wherein the at least one porous bearing pad is of graded porosity.

31. The hydrodynamic journal bearing of claim 28, wherein the at least one porous bearing pad includes parts or layers of varying porosity.

32. The hydrodynamic journal bearing of claim 28, wherein at least a portion of the at least one porous bearing pad is impermeable with respect to the high-viscosity lubricant.

33. The hydrodynamic journal bearing of claim 28, wherein the high-viscosity lubricant comprises synthetic oil or mineral oil and the low-viscosity lubricant comprises water.

34. The hydrodynamic journal bearing of claim 28, wherein the low-viscosity lubricant has a viscosity that is about 1/100^{th} of a viscosity of the high-viscosity lubricant.
